(19) United States
(12) Patent Application Publication
(10) Pub. No.: US 2009/0187419 A1
(43) Pub. Date: Jul. 23, 2009

(54) Systems And Methods For A Decision Support Alert Feed

(75) Inventors: Karthikeyan Renganathan, Holladay, UT (US); Michael Thomas Randazzo, South Jordan, UT (US); Randy Kent Secrist, West Jordan, UT (US); John Alan Harris, West Jordan, UT (US); Darin Ford Wilcox, Centerville, UT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/017,190

(22) Filed: Jan. 21, 2008

(51) Int. Cl. G06Q 50/00

(52) U.S. Cl. 705/2

(57) ABSTRACT

Certain embodiments of the present invention provide a clinical decision support system comprising a clinical decision support processing component adapted to determine the occurrence of an event based at least in part on at least one message received by the clinical decision support processing component and an alert feed server adapted to publish a clinical alert to an alert feed based at least in part on the event. The alert feed is in a standard syndication format.

### BACKGROUND OF THE INVENTION

The present invention generally relates to clinical decision support systems. In particular, the present invention relates to systems and methods for a decision support alert feed.

Healthcare environments, such as hospitals or clinics, include information management systems such as healthcare information systems (HIS), radiology information systems (RIS), clinical information systems (CIS), cardiovascular information systems (CVIS), picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations.

Healthcare practitioners may desire to access patient information or other information at various points in a healthcare workflow. For example, during surgery, medical personnel may access patient information, such as images of a patient's anatomy, which are stored in an information management system. Alternatively, medical personnel may enter new information, such as history, diagnostic, or treatment information, into an information management system when examining a patient in a hospital. As another example, medical personnel may enter new orders for patients. Orders may include, for example, basic medication to be given to a patient and/or a procedure or exam to be conducted.

Clinical decision support systems provide assistance to healthcare providers such as physicians. For example, clinical decision support systems can aid a physician in making decisions regarding diagnosis and/or treatment. As another example, clinical decision support systems may perform interaction checking on prescription orders for possible adverse drug interactions. A clinical decision support system may be part of an information management system such as a CIS and/or HIS, for example. A clinical decision support system may utilize information stored in and/or received in messages from other systems such as RIS, CVIS, PACS, LIS, EMR, order entry system, medication management system, and/or a pharmacy application.

Clinical decision support systems may send alerts (also referred to as clinical alerts) to healthcare providers. These alerts may notify the healthcare provider, such as a treating physician, nurse, or clinician, of events that have occurred. In current systems, generated alerts are made available to special-purpose client applications using protocols such as simple object access protocol (SOAP) and remote method invocation (RMI). These protocols require the client application to conform to a proprietary format for communication and interpretation of the alerts generated by the clinical decision support system. Thus, the kind of client application which can view alerts is limited. In addition, client applications using these protocols are sensitive to the modifications in the structure of the alerts, resulting in client applications having to be updated every time the alert structures are changed.

### BRIEF SUMMARY OF THE INVENTION

Certain embodiments of the present invention provide a clinical decision support system comprising a clinical decision support processing component adapted to determine the occurrence of an event based at least in part on at least one message received by the clinical decision support processing component and an alert feed server adapted to publish a clinical alert to an alert feed based at least in part on the event. The alert feed is in a standard syndication format.

Certain embodiments of the present invention provide a method for providing a clinical decision support alert feed comprising receiving a message at a clinical decision support processing component, processing the message to determine whether an event has occurred, and publishing a clinical alert to an alert feed based at least in part on the event. The alert feed is in a standard syndication format.

Certain embodiments of the present invention provide a computer-readable medium including a set of instructions for execution on a computer, the set of instructions comprising a clinical decision support processing routine configured to determine the occurrence of an event based at least in part on at least one message received by the clinical decision support processing routine and an alert feed server routine adapted to publish a clinical alert to an alert feed based at least in part on the event. The alert feed is in a standard syndication format.

### BRIEF DESCRIPTION OF SEVERAL VIEWS OF THE DRAWINGS

FIG. 1 illustrates a clinical decision support system according to an embodiment of the present invention.

FIG. 2 illustrates a user interface for an alert feed client implemented as a rich client according to an embodiment of the present invention.

FIG. 3 illustrates a user interface for an alert feed client implemented as a web browser according to an embodiment of the present invention.

FIG. 4 illustrates a flow diagram for a method for providing a clinical decision support alert feed according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a decision support alert feed. Certain embodiments provide for the posting of clinical alerts using a feed in a standard syndication format such as Atom or RSS. Certain embodiments allow a user, such as a treating physician, nurse, or other healthcare provider, to view clinical alerts using third-party applications, such as generally-available feed readers. Certain embodiments allow for reduced costs to users because third-party feed readers may be inexpensive or free.

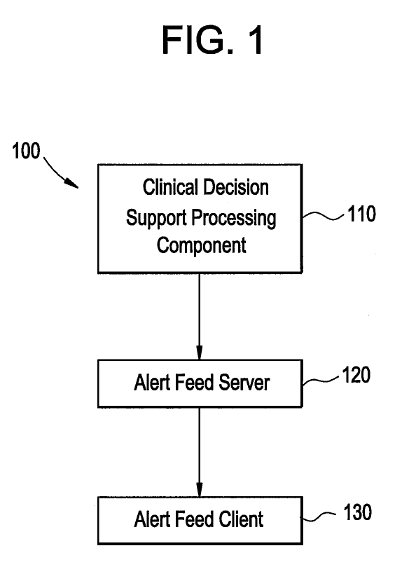

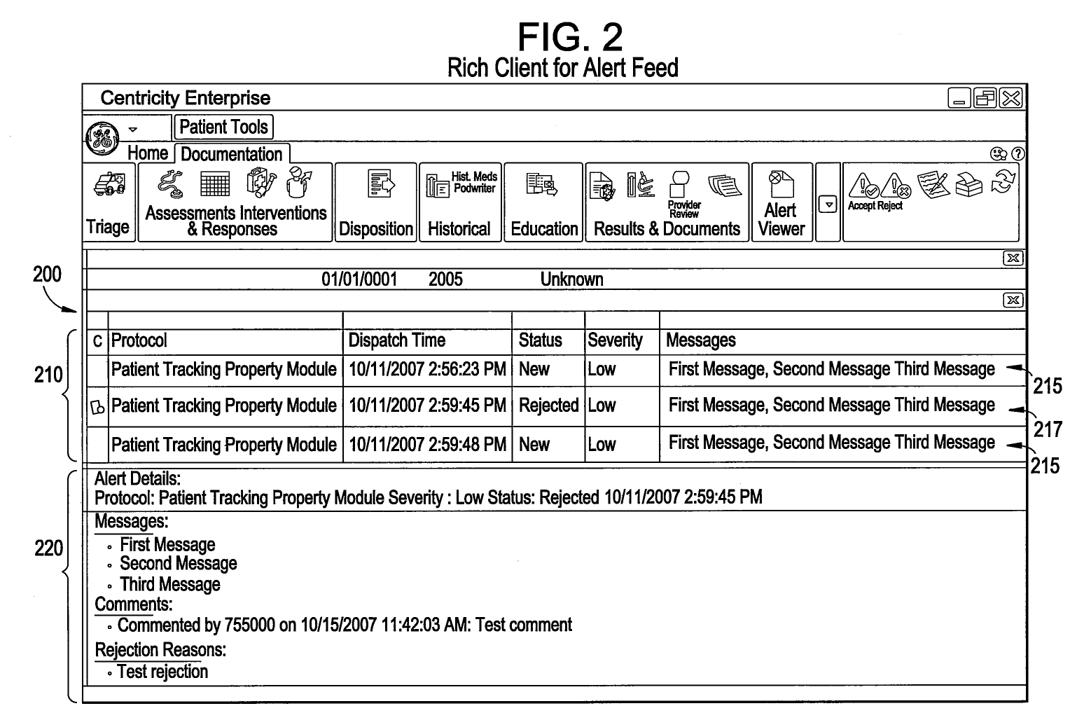

FIG. 1 illustrates a clinical decision support system 100 according to an embodiment of the present invention. The system 100 includes a clinical decision support processing component 110, an alert feed server 120, and an alert feed client 130.

The alert feed server 120 is in communication with the clinical decision support processing component 110 and the alert feed client 130.

In operation, the clinical decision support processing component 110 receives messages. The messages may be received from, for example, other components in an information management system such as a CIS or HIS, for example. The clinical decision support processing component 110 determines whether an event has occurred based at least in part on processing the received messages. The alert feed server 120 provides a clinical alert to an alert feed in a standard syndication format based on the event. The alert feed client 130 may be used by a healthcare provider to receive clinical alerts published over the alert feed.

The clinical decision support processing component 110 is adapted to receive messages in an information management system such as a CIS or HIS, for example. For example, the clinical decision support processing component 110 may receive messages from, for example, a pharmacy system, a lab system, an order entry system, a medication management system, an admission discharge transfer system, RIS, PACS, LIS, EMR, or other part of an HIS. The message may be received over a computer network or other communications interface, for example. The message may conform, at least in part, to the HL7 protocol or other communications protocol, for example. The message may indicate, for example, a lab result has become available for Patient A. As another example, the message may indicate an x-ray procedure has been ordered for Patient B.

The clinical decision support processing component 110 is adapted to process the received messages to determine the occurrence of an event. That is, the clinical decision support processing component 110 may determine whether an event has occurred based at least in part on the received messages. For example, the clinical decision support processing component 110 may receive a message including a lab result for a particular patient. An event may be determined to have occurred if the patient's potassium level has dropped by 10%. In other words, when a message is received containing data regarding the potassium level for a particular patient, if that level value is 10% less than the previously received value, an event has occurred. The clinical decision support processing component 110 may evaluate data included in one or more messages along with other data available to the clinical decisions support processing component 110 stored in an information management system such as a CIS, HIS, or PACS, for example.

An event may include, for example, a value increasing a certain amount, at a certain rate, or over a particular time period. For example, a potassium level in a patient dropping by 10% in one day may be an event. As another example, a patient's heart rate dropping below 60 beats per minute and the patient taking the medication Digoxin may be an event. As another example, a drop in a patient's blood pressure by 15% over a one hour period may be an event.

In certain embodiments, the clinical decision support processing component 110 includes a rules engine to process and/or evaluate a received message to determine the occurrence of an event. For example, a rule may include a condition such as “if patient's potassium level drops by ten percent, then alert the patient's attending physician.” Thus, when a message is received containing data regarding the potassium level for a particular patient, if that level value is 10% less than the previously received value, an event has occurred. More specifically, the event is the 10% drop in a patient's potassium level. In certain embodiments, the rules are user-defined.

A rule may be specified at the site level. For example, one or more rules may be defined for a site, such as a clinic or hospital, that relate to general operating procedures. As an example, a rule, similar to the rule discussed above, may be specified to monitor the potassium level for all patients. A rule may be defined for a specific patient and/or group of patients. For example, one or more rules may be defined that are specific to a particular patient. As another example, one or more rules may be defined that are specific to a group of patients, such as those in an intensive care unit (ICU). These more specific rules may be targeted to the particular condition and/or situation of the particular patient or group of patients. It should be noted that rules that are more general in nature may still be triggered on a per-patient basis. That is, for example, a general rule relating to potassium levels will still be evaluated in the context of each individual patient. More specific rules may only be evaluated in the context of patients that fit within the constraints of those rules. For example, a rule specific to patients in the ICU may not be evaluated for patients not in the ICU.

The alert feed server 120 is adapted to publish a clinical alert to an alert feed. The clinical alert may be based at least in part on the event determined by the clinical decision support processing component 110, discussed above, for example.

The clinical alert may include information related to the event. For example, the alert may include a patient's name, information about why the event was determined to have occurred, etc.

The alert feed server 120 is adapted to provide the alert feed. The alert feed is in a standard syndication format. The alert feed may be a web feed that is syndicated by the alert feed server 120, for example. For example, users may subscribe to the alert feed to receive the clinical alerts. In certain embodiments, the alert feed is a document that contains items with links to more detailed items. For example, the alert feed may include a series of clinical alert summaries with links to the full clinical alert. Alternatively, the alert feed may include the entire clinical alert.

In certain embodiments, the alert feed is in the Atom format. In certain embodiments, the alert feed is in the RSS (RDF Site Summary or Really Simple Syndication) format. In certain embodiments, the alert feed utilizes a module adapted for publishing clinical alerts.

The Health Insurance Portability and Accountability Act (HIPAA) provides for a variety of requirements for the protection of the privacy of patients. In certain embodiments, the published clinical alerts take into account HIPAA, privacy, and/or confidentiality parameters. Security and/or privacy of patient data may be utilized in the alert feed, for example. For example, in order to subscribe to the alert feed, a client application may be required to be authenticated. In certain embodiments, the alert feed server 120 requires a user to be authenticated before the alert feed is accessed. The alert feed client 130 may pass user credentials to the alert feed server 120, for example. The alert feed server 120 may then authenticate the user and encrypt the feed using an encryption key specific to that user, such as that user's key pair, for example. As another example, the alert feed may allow individual components of a clinical alert may be encrypted. In certain embodiments, the alert feed server 120 only provides alerts that the user is authenticated for.

The alert feed client 130 is adapted to receive a clinical alert from an alert feed. In addition, the alert feed client 130 may be adapted to subscribe to the alert feed. The alert feed may be the alert feed provided by the alert feed server 120, discussed above, for example. The clinical alert may be similar to the clinical alert described above, for example. The clinical alert may be the clinical alert published by the alert feed server 120, discussed above, for example.

The alert feed client 130 may be a software application, for example. For example, the alert feed client 130 may be a stand-alone application. As another example, the alert feed client 130 may be part of a generally-available feed reader or aggregator. As another example, the alert feed client 130 may be an open source feed reader or web browser.

In certain embodiment, the alert feed client 130 is a rich client. For example, the alert feed client 130 may be a software application adapted to run on a personal computer. As another example, the alert feed client 130 may be part of a software package of proprietary software as part of a CIS and/or HIS workstation, for example.

FIG. 2 illustrates a user interface 200 for an alert feed client 130 implemented as a rich client according to an embodiment of the present invention. The user interface 200 includes an alert listing panel 210 and an alert display panel 220.

The alert listing panel 210 includes a list of clinical alert entries 215 published in the alert feed. The clinical alert entries 215 may include summary information for each published clinical alert such as protocol, dispatch time, status, severity, and messages.

The alert display panel 220 displays the details of a clinical alert whose corresponding clinical alert entry 215 has been selected 217 in the alert listing panel 210. The alert display panel 220 may then display the protocol, dispatch time, status, severity, messages, comments, reasons for the status for the selected clinical alert entry 217, for example.

In certain embodiment, the alert feed client 130 is a web browser. For example, the alert feed client 130 may be a standard web browser supporting the display of HTML and/or XML.

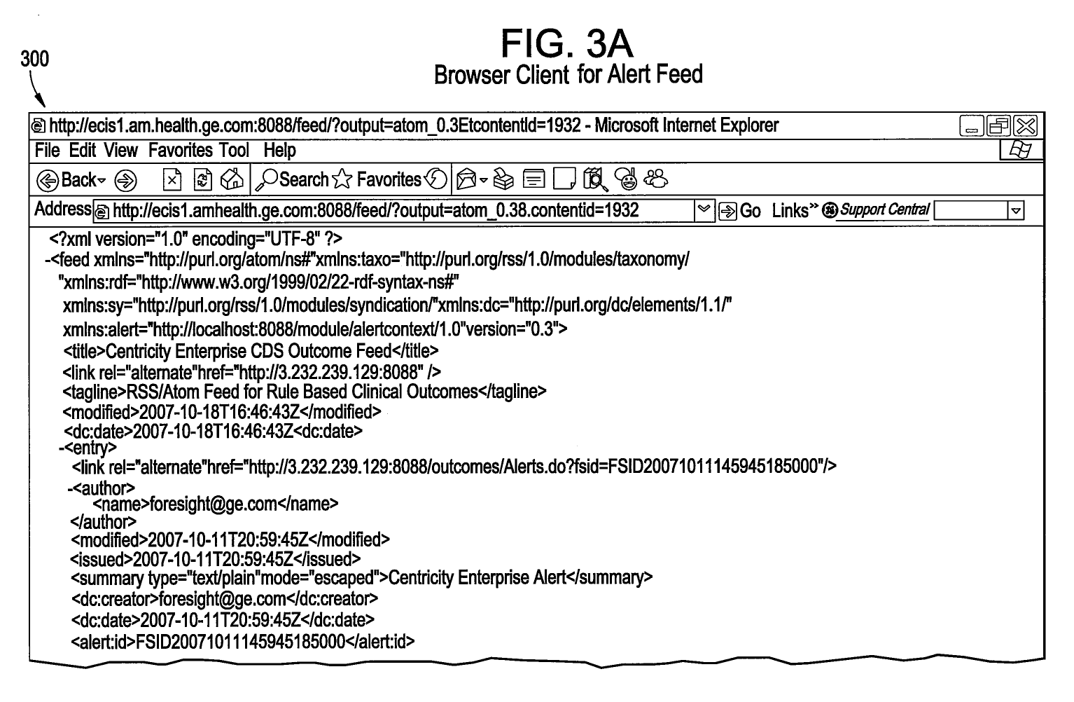

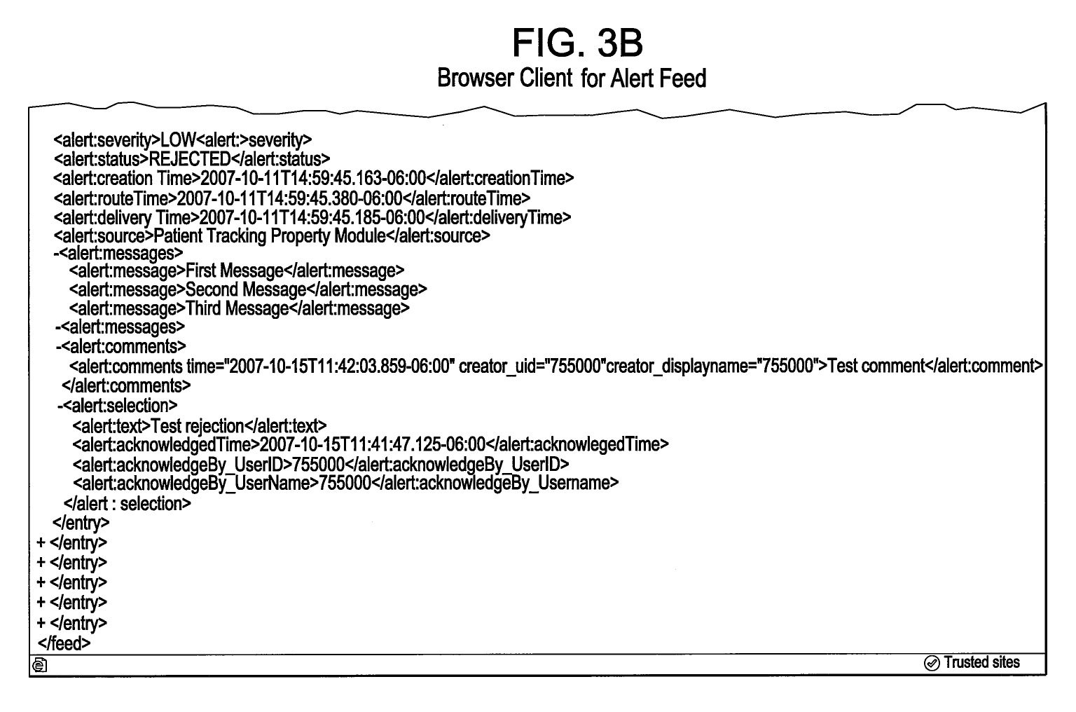

FIG. 3 illustrates a user interface 300 for an alert feed client 130 implemented as a web browser according to an embodiment of the present invention. The user interface 300, as illustrated in FIG. 3, includes a listing of the clinical alerts published to the alert feed in XML form.

In certain embodiments, the alert feed client 130 is provided by a third party. For example, the alert feed client 130 may be an open-source web browser or commercially available RSS or Atom feed reader or aggregator.

In certain embodiments, the alert feed client 130 is adapted to run on a mobile device. For example, the alert feed client 130 may run on a physician's PDA. As another example, the alert feed client 130 may be part of a handheld device.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

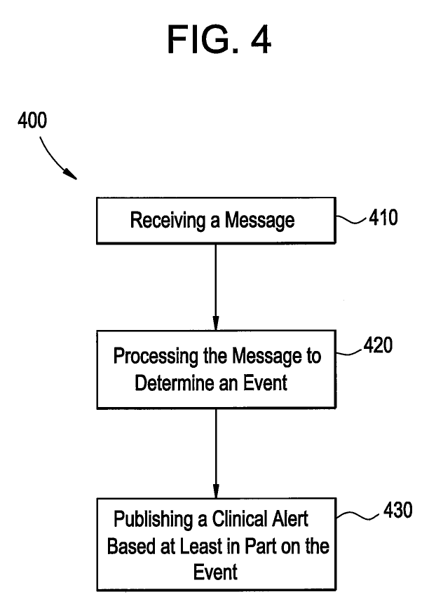

FIG. 4 illustrates a flow diagram 400 for a method for providing a clinical decision support alert feed according to an embodiment of the present invention. The method includes the following steps, which will be described below in more detail. At step 410, a message is received. At step 420, the message is processed to determine an event. At step 430, a clinical alert is published based at least in part on the event. The method is described with reference to elements of systems described above, but it should be understood that other implementations are possible.

At step 410, a message is received. The message may be received by a clinical decision support processing component similar to the clinical decision support processing component 110, described above, for example.

The messages may be received from, for example, other components in an information management system such as a CIS or HIS, for example. For example, the message may be received from a pharmacy system, a lab system, an order entry system, a medication management system, an admission discharge transfer system, RIS, PACS, LIS, EMR, or other part of an HIS. The message may be received over a computer network or other communications interface, for example. The message may conform, at least in part, to the HL7 protocol or other communications protocol, for example. The message may indicate, for example, a lab result has become available for Patient A. As another example, the message may indicate an x-ray procedure has been ordered for Patient B.

At step 420, the message is processed to determine an event. The message may be the message received at step 410, described above, for example. The message may be processed by a clinical decision support processing component similar to the clinical decision support processing component 110, described above, for example. The event may be similar to the event described above, for example.

The message is processed to determine the occurrence of an event. The determination of whether an event has occurred is based at least in part on the received messages. For example, the clinical decision support processing component may receive a message including a lab result for a particular patient. An event may be determined to have occurred if the patient's potassium level has dropped by 10%. In other words, when a message is received containing data regarding the potassium level for a particular patient, if that level value is 10% less than the previously received value, an event has occurred. Data included in one or more messages along with other data stored in an information management system such as a CIS, HIS, or PACS may be evaluated to determine whether an event has occurred, for example.

An event may include, for example, a value increasing a certain amount, at a certain rate, or over a particular time period. For example, a potassium level in a patient dropping by 10% in one day may be an event. As another example, a patient's heart rate dropping below 60 beats per minute and the patient taking the medication Digoxin may be an event. As another example, a drop in a patient's blood pressure by 15% over a one hour period may be an event.

In certain embodiments, the determination of the occurrence of an event is made by a rules engine. The rules engine may be similar to the rules engine described above, for example. The rules engine may be part of a clinical decision support processing component, for example.

At step 430, a clinical alert is published based at least in part on the event. The event may be the event determined at step 420, discussed above, for example.

The clinical alert may be similar to the clinical alert discussed above, for example. The clinical alert may be published by a clinical alert server similar to the clinical alert server 120, discussed above, for example. The clinical alert may include information related to the event. For example, the alert may include a patient's name, information about why the event was determined to have occurred, etc.

The clinical alert may be published to an alert feed. The alert feed may be similar to the alert feed discussed above, for example. The alert feed is in a standard syndication format. The alert feed may be a web feed that is syndicated by an alert feed server, for example. For example, users may subscribe to the alert feed to receive the clinical alerts. In certain embodiments, the alert feed is a document that contains items with links to more detailed items. For example, the alert feed may include a series of clinical alert summaries with links to the full clinical alert. Alternatively, the alert feed may include the entire clinical alert.

In certain embodiments, the alert feed is in the Atom format. In certain embodiments, the alert feed is in the RSS (RDF Site Summary or Really Simple Syndication) format. In certain embodiments, the alert feed utilizes a module adapted for publishing clinical alerts.

In certain embodiments, the published clinical alerts take into account HIPAA, privacy, and/or confidentiality parameters. Security and/or privacy of patient data may be utilized in the alert feed, for example. For example, in order to subscribe to the alert feed, a client application may be required to be authenticated. In certain embodiments, the a user is required to be authenticated before the alert feed is accessed. Once a user is authenticated, the alert feed may be encrypted using an encryption key specific to that user, such as that user's key pair, for example. As another example, the alert feed may allow individual components of a clinical alert may be encrypted. In certain embodiments, the clinical alerts are only provided that the user is authenticated for.

In certain embodiments, the clinical alert is received at an alert feed client similar to the alert feed claim 130, discussed above. In certain embodiments, the alert feed client is adapted to subscribe to the alert feed. The alert feed client may be a software application, for example. For example, the alert feed client may be a stand-alone application. As another example, the alert feed client may be part of a generally-available feed reader or aggregator. As another example, the alert feed client may be an open source feed reader or web browser.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments of the present invention provide a decision support alert feed. Certain embodiments provide for the posting of clinical alerts using a feed in a standard syndication format such as Atom or RSS. Certain embodiments allow a user to view clinical alerts using third-party applications. In addition, certain embodiments of the present invention provide technical effect of a decision support alert feed. Certain embodiments provide a technical effect of posting of clinical alerts using a feed in a standard syndication format such as Atom or RSS. Certain embodiments provide a technical effect of allowing a user to view clinical alerts using third-party applications.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical information management system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A clinical decision support system comprising:
a clinical decision support processing component adapted to determine the occurrence of an event based at least in part on at least one message received by the clinical decision support processing component; and
an alert feed server adapted to publish a clinical alert to an alert feed based at least in part on the event, wherein the alert feed is in a standard syndication format.

2. The system of claim 1, wherein the alert feed is in the Atom format.

3. The system of claim 1, wherein the alert feed is in RSS format.

4. The system of claim 1, wherein the clinical decision support processing component determines the occurrence of the event using a rules engine.

5. The system of claim 1, further including an alert feed client adapted to receive the clinical alert from the alert feed server.

6. The system of claim 5, wherein the alert feed client is provided by a third party.

7. The system of claim 5, wherein the alert feed client is a rich client.

8. The system of claim 5, wherein the alert feed client is a web browser.

9. The system of claim 1, wherein the alert feed requires a user to be authenticated before the alert feed is accessed.

10. The system of claim 9, wherein the alert feed is encrypted with an encryption key specific to the user.

11. The system of claim 1, wherein at least part of the clinical alert includes encrypted data.

12. A method for providing a clinical decision support alert feed comprising:
receiving a message at a clinical decision support processing component;
processing the message to determine whether an event has occurred; and
publishing a clinical alert to an alert feed based at least in part on the event, wherein the alert feed is in a standard syndication format.

13. The method of claim 12, wherein the alert feed is in the Atom format.

14. The method of claim 12, wherein the alert feed is in RSS format.

15. The method of claim 12, wherein the alert feed requires a user to be authenticated before the alert feed is accessed.

16. The method of claim 15, wherein the alert feed is encrypted with an encryption key specific to the user.

17. The method of claim 12, wherein at least part of the clinical alert includes encrypted data.

18. A computer-readable medium including a set of instructions for execution on a computer, the set of instructions comprising:
a clinical decision support processing routine configured to determine the occurrence of an event based at least in part on at least one message received by the clinical decision support processing routine; and
an alert feed server routine adapted to publish a clinical alert to an alert feed based at least in part on the event, wherein the alert feed is in a standard syndication format.

19. The computer-readable medium of claim 18, wherein the alert feed is in the Atom format.

20. The computer-readable medium of claim 18, wherein the alert feed is in RSS format.
